(19) United States
(12) Patent Application Publication
(10) Pub. No.: US 2021/0056050 A1
(43) Pub. Date: Feb. 25, 2021

(54) PREPROCESSING DETERMINATION APPARATUS, PREPROCESSING DETERMINATION METHOD, AND PROGRAM

(71) Applicant: OMRON CORPORATION, kyoto-shi, Kyoto (JP)

(72) Inventors: Tetsuji YAMATO, Yokohama-shi (JP); Taiji YOSHIKAWA, Kizugawa-shi (JP)

(73) Assignee: OMRON Corporation, Kyoto-shi, Kyoto (JP)

(21) Appl. No.: 16/962,385

(22) PCT Filed: Nov. 29, 2018
(86) PCT No.: PCT/JP2018/043929

§ 371 Date: Jul. 15, 2020

(30) Foreign Application Priority Data
Feb. 13, 2018 (JP) 2018-022798

(51) Int. Cl. G06F 13/12; G06F 16/907; H04L 29/08

(52) U.S. Cl. CPC G06F 13/126; H04L 67/12; G06F 16/907

(57) ABSTRACT

A preprocessing determination apparatus, a preprocessing determination method, and a preprocessing determination program perform determination for preprocessing of input data to be input into a processing module. The processing module is associated with first metadata indicating a condition of the input data. The input data is associated with second metadata indicating an attribute of the input data. The preprocessing determination apparatus includes a first obtaining unit, a second obtaining unit, and a determination unit. The first obtaining unit obtains the first metadata. The second obtaining unit obtains the second metadata. The determination unit performs the determination for the preprocessing of the input data based on the first metadata and the second metadata.

### FIELD

The present invention relates to a preprocessing determination apparatus, a preprocessing determination method, and a preprocessing determination program.

### BACKGROUND

Japanese Unexamined Patent Application Publication No. 2014-45242 (Patent Literature 1) describes a virtual sensor generation apparatus that generates a virtual sensor. This virtual sensor generation apparatus detects a real sensor located within a predetermined range and generates a virtual sensor using the detected real sensor (refer to Patent Literature 1).

### CITATION LIST

### Patent Literature

Patent Literature 1: Japanese Unexamined Patent Application Publication No. 2014-45242

### SUMMARY

### Technical Problem

The virtual sensor described in Patent Literature 1 includes, for example, a real sensor (an example of a device) and a processing module. The processing module processes sensing data (an example of input data) output from the real sensor to generate output data different from the input data.

The processing module may have a predetermined format for input data (e.g., the unit and the number of digits). The processing module may inappropriately process data input in a format different from the predetermined format. To avoid this, the input data is to be preprocessed before being input into the processing module. However, Patent Literature 1 does not describe preprocessing of input data.

In response to the above issue, one or more aspects of the present invention are directed to a preprocessing determination apparatus, a preprocessing determination method, and a preprocessing determination program for performing appropriate determination for preprocessing of input data to be input into a processing module.

### Solution to Problem

A preprocessing determination apparatus according to one aspect of the present invention is an apparatus for performing determination for preprocessing of input data to be input into a processing module. The processing module generates, based on at least one piece of the input data, output data different from the at least one piece of input data. The processing module is associated with first metadata indicating a condition of the input data. The input data is associated with second metadata indicating an attribute of the input data. The preprocessing determination apparatus includes a first obtaining unit, a second obtaining unit, and a determination unit. The first obtaining unit obtains the first metadata. The second obtaining unit obtains the second metadata. The determination unit performs the determination for the preprocessing of the input data based on the first metadata and the second metadata.

This preprocessing determination apparatus performs determination for preprocessing of the input data based on the first metadata and the second metadata. The preprocessing determination apparatus thus performs determination for preprocessing using the condition and the attribute of input data to be input into the processing module. The preprocessing determination apparatus uses relevant information about preprocessing and can thus perform appropriate determination for the preprocessing.

The input data may be output to the processing module by a device. The device may output the input data and the second metadata separately. The second metadata may be output to the preprocessing determination apparatus by the device.

The preprocessing determination apparatus simply receives the second metadata. The preprocessing determination apparatus can perform appropriate determination for preprocessing while reducing the communication traffic between the device and the preprocessing determination apparatus.

The input data may be associated with the second metadata using an identification.

The preprocessing determination apparatus associates the input data with the second metadata using identifications (IDs). Although the input data and the second metadata are processed separately, the preprocessing determination apparatus relinks the input data with the second metadata by referring to the IDs.

The preprocessing determination apparatus may further include a storage. The storage may store a past determination result obtained by the determination unit. The determination unit may perform the determination for the preprocessing based on the first metadata, the second metadata, and the past determination result.

The preprocessing determination apparatus uses the past determination result in addition to the first metadata and the second metadata to perform determination for preprocessing. The preprocessing determination apparatus can thus perform more appropriate determination for preprocessing using the past determination result.

The preprocessing may be performed on the input data to cause the input data to satisfy the condition of the input data.

The input data may be output to the processing module by a device. The device may be a sensor. The input data may be sensing data generated by the sensor.

The processing module may generate the output data based on a plurality of pieces of the input data.

The input data may be output to the processing module by a device. The processing module may switch the device that outputs the input data to the processing module.

The input data may be output to the processing module by a device. The processing module and the device that outputs the input data to the processing module may form a virtual sensor.

A preprocessing determination method according to another aspect of the present invention is a method for performing determination for preprocessing of input data to be input into a processing module. The processing module generates, based on at least one piece of the input data, output data different from the at least one piece of input data. The processing module is associated with first metadata indicating a condition of the input data. The input data is associated with second metadata indicating an attribute of the input data. The preprocessing determination method includes obtaining the first metadata, obtaining the second metadata, and performing the determination for the preprocessing of the input data based on the first metadata and the second metadata.

This preprocessing determination method performs determination for preprocessing of the input data based on the first metadata and the second metadata. The preprocessing determination method thus performs the determination for preprocessing using the condition and the attribute of input data to be input into the processing module. The preprocessing determination method uses relevant information about preprocessing and can thus perform appropriate determination for the preprocessing.

A program according to still another aspect of the present invention causes a computer to perform determination for preprocessing of input data to be input into a processing module. The processing module generates, based on at least one piece of the input data, output data different from the at least one piece of input data. The processing module is associated with first metadata indicating a condition of the input data. The input data is associated with second metadata indicating an attribute of the input data. The program causes the computer to implement obtaining the first metadata, obtaining the second metadata, and performing the determination for the preprocessing of the input data based on the first metadata and the second metadata.

This program is executed by the computer to perform determination for preprocessing of the input data based on the first metadata and the second metadata. The program is executed by the computer to perform the determination for preprocessing using the condition and the attribute of input data to be input into the processing module. The program uses relevant information about preprocessing and can thus perform appropriate determination for the preprocessing.

### Advantageous Effects

The preprocessing determination apparatus, the preprocessing determination method, and the preprocessing determination program according to the aspects of the present invention can perform appropriate determination for preprocessing of input data to be input into the processing module.

### BRIEF DESCRIPTION OF THE DRAWINGS

FIG. 1 is a schematic diagram of a preprocessing determination apparatus.

FIG. 2 is a diagram showing an example sensor network system.

FIG. 3 is a diagram of a virtual sensor management server showing its example hardware configuration.

FIG. 4 is a table showing an example preprocessing program database (DB).

FIG. 5 is a table showing an example past determination history DB.

FIG. 6 is a table showing an example processing module metadata DB.

FIG. 7 is a diagram of a sensing device showing its example hardware configuration.

FIG. 8 is a table showing example sensing data metadata.

FIG. 9 is a diagram showing an example relationship between software modules implemented by a controller.

FIG. 10 is a diagram of a preprocessing determination module showing its detailed example configuration.

FIG. 11 is a diagram showing example IDs assigned to data.

FIG. 12 is a diagram of an output management module showing its detailed example configuration.

FIG. 13 is a diagram of a preprocessing module showing its detailed example configuration.

FIG. 14 is a flowchart showing an example of a preprocessing determination operation.

FIG. 15 is a flowchart showing an example operation for managing output of sensing data from the sensing device to a processing module.

FIG. 16 is a flowchart showing an example of a preprocessing operation.

### DETAILED DESCRIPTION

One or more embodiments of the present invention (hereafter, the present embodiment) will now be described in detail with reference to the drawings. The same or corresponding components in the figures are given the same reference numerals, and will not be described repeatedly. The present embodiment described below is a mere example of the present invention in all aspects. The present embodiment may be variously modified or altered within the scope of the present invention. More specifically, the present invention may be implemented as appropriate using any configuration specific to each embodiment.

### 1. Overview

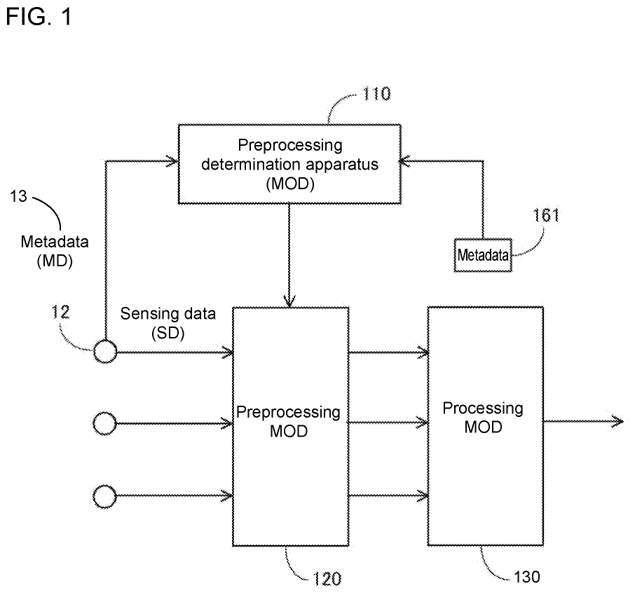

FIG. 1 is a schematic diagram of a preprocessing determination apparatus (module) 110 according to the present embodiment. Referring to FIG. 1, a processing module 130 includes multiple input ports. Each input port receives sensing data (an example of input data) output from a sensing device 12 (an example of a device). Based on input data, the processing module 130 generates output data different from the input data. In other words, the processing module 130 and the sensing devices 12 (input sensors) that output input data to the processing module 130 form a virtual sensor. The virtual sensor is a sensor module that outputs, based on sensing data resulting from the input sensor observing a target, the observation results of a target different from the target observed by the input sensor as sensing data. The virtual sensor will be described in detail later.

The processing module 130 may have a predetermined format for input data (e.g., the unit and the number of digits). The processing module 130 may inappropriately process data input in a format different from the predetermined format. To avoid this, the input data is to be preprocessed before being input into the processing module 130. The preprocessing is performed on input data to cause the input data to satisfy the conditions of input data to be input into the processing module 130.

The preprocessing determination apparatus 110 according to the present embodiment performs determination for preprocessing of input data to be input into the processing module 130. More specifically, the preprocessing determination apparatus 110 obtains processing module metadata (hereafter, first metadata) 161 and sensing data metadata (hereafter, second metadata) 13. The first metadata 161 is associated with the processing module 130 and indicates the conditions of input data to be input into the processing module 130. The second metadata 13 is associated with sensing data output from the sensing device 12 and indicates the attributes of the sensing data (input data). The preprocessing determination apparatus 110 performs determination for preprocessing of input data to be input into the processing module 130 based on the first metadata 161 and the second metadata 13.

The preprocessing determination apparatus 110 thus performs determination for preprocessing using the conditions and the attributes of input data to be input into the processing module 130. The preprocessing determination apparatus 110 uses relevant information about the preprocessing and can thus perform appropriate determination for the preprocessing.

### 2. Configuration

### 2-1. Configuration of Entire System

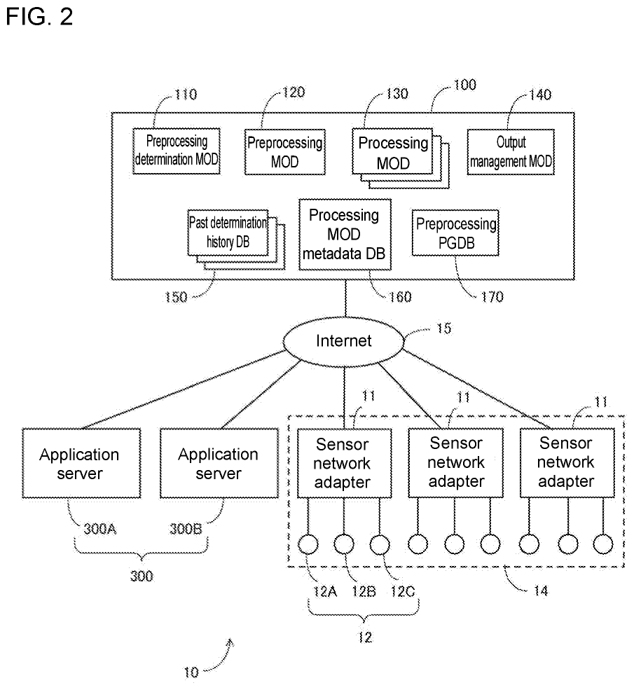

FIG. 2 is a diagram showing an example sensor network system 10 including the preprocessing determination module (apparatus) 110 according to the present embodiment. In the example in FIG. 2, the sensor network system 10 includes a sensor network unit 14, a virtual sensor management server 100, and application servers 300.

The sensor network unit 14, the virtual sensor management server 100, and the application servers 300 are connected to one another through the Internet 15 to allow communication between them. The sensor network system 10 may include either more or fewer components (including the virtual sensor management server 100, the application servers 300, sensor network adapters 11, and the sensing devices 12) than the components shown in FIG. 2.

In the sensor network system 10, sensing data generated by, for example, the sensing devices 12 can be distributed. For example, sensing data generated by the sensing devices 12 can be distributed to the virtual sensor management server 100, and sensing data generated by the virtual sensors can be distributed to the application servers 300.

The sensor network unit 14 includes, for example, multiple sensor network adapters 11. Each sensor network adapter 11 is connected to multiple sensing devices 12. The sensing devices 12 are connected to the Internet 15 through each sensor network adapter 11.

Each sensing device 12 observes a target to provide sensing data. Each sensing device 12 may be an image sensor (camera), a temperature sensor, a humidity sensor, an illumination sensor, a force sensor, a sound sensor, a radio frequency identification (RFID) sensor, an infrared sensor, a posture sensor, a rain sensor, a radiation sensor, or a gas sensor. Each sensing device 12 may be a stationary sensor, or a mobile sensor, such as a mobile phone, a smartphone, or a tablet. Each sensing device 12 may be a single sensor, or may include multiple sensors. The sensing devices 12 may be installed for any purposes. For example, the sensing devices 12 may be installed for factory automation (FA) and production management at a factory, urban traffic control, weather or other environmental measurement, healthcare, or crime prevention.

In the sensor network unit 14, for example, the sensor network adapters 11 are located at different sites (remote from one another), and the sensing devices 12 connected to each sensor network adapter 11 are located at the same site (or close sites). The sensor network adapters 11 and the sensing devices 12 may be located in a different manner.

Each application server 300 (300A or 300B) executes an application that uses sensing data, and is implemented by, for example, a general-purpose computer. The application server 300 obtains sensing data for use through the Internet 15.

The virtual sensor management server 100 implements a virtual sensor. The virtual sensor management server 100 implements multiple processing modules 130, a preprocessing module 120, the preprocessing determination module 110, and an output management module 140, and manages a preprocessing program database (DB) 170, past determination history DBs 150, and a processing module metadata DB (hereafter, a first metadata DB) 160. The multiple processing modules 130, the preprocessing module 120, the preprocessing determination module 110, and the output management module 140 are, for example, software modules.

Each processing module 130 includes at least one input port and generates output data different from input data input into the input port based on the input data. The processing module 130 switches the sensing device 12 that outputs input data to the input port as appropriate. When, for example, the sensing device 12 currently outputting input data to the input port becomes faulty, the processing module 130 switches the input sensor to another sensing device 12.

For example, the processing module 130 may output data representing the number of people in a room based on input data (audio data) output from a sound sensor installed in the room. In this case, the processing module 130 and the sensing device 12 (sound sensor) can implement a virtual sensor that detects the number of people in a room.

The preprocessing module 120 performs intended preprocessing of input data to be input into the processing module 130 by executing preprocessing programs (described later). The preprocessing determination module 110 performs determination for preprocessing of input data to be input into the processing module 130. The output management module 140 manages output of input data from the sensing devices 12 to the processing module 130. Each software module and each database will be described in detail later.

### 2-2. Hardware Configuration of Virtual Sensor Management Server

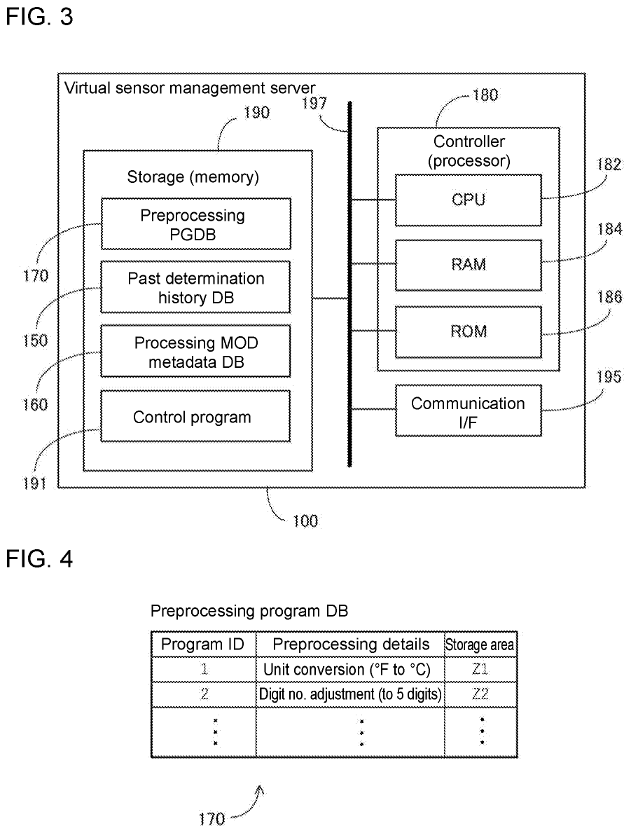

FIG. 3 is a diagram of the virtual sensor management server 100 showing its example hardware configuration. The virtual sensor management server 100 according to the present embodiment is implemented by, for example, a general-purpose computer.

In the example in FIG. 3, the virtual sensor management server 100 includes a controller 180, a communication interface (I/F) 195, and a storage 190. The components are electrically connected to one another with a bus 197.

The controller 180 includes, for example, a central processing unit (CPU) 182, a random-access memory (RAM) 184, and a read-only memory (ROM) 186. The controller 180 controls each unit in accordance with the information processing to be performed.

The communication I/F 195 communicates with external devices (e.g., the application server 300, and the sensor network unit 14 in FIG. 2) external to the virtual sensor management server 100 through the Internet 15. The communication I/F 195 includes, for example, a wired local area network (LAN) module and a wireless LAN module.

The storage 190 is an auxiliary storage device such as a hard disk drive or a solid-state drive. The storage 190 stores, for example, the preprocessing program DB 170, the past determination history DBs 150, the first metadata DB 160, and a control program 191.

FIG. 4 is a table showing an example preprocessing program DB 170. The preprocessing program DB 170 manages multiple preprocessing programs. In the example in FIG. 4, the preprocessing program DB 170 manages a program identification (ID), preprocessing details, and a storage area in a manner associated with one another. The program ID is information for uniquely identifying each preprocessing program. The preprocessing details are the details of preprocessing performed by executing each preprocessing program. The storage area is information (e.g., an address in memory) for identifying an area storing each preprocessing program.

In this example, a preprocessing program with a program ID of 1 is a program for converting the unit of input data to be input into the processing module 130 and is stored in an address of Z1 in the memory. The unit conversion, which is an example of preprocessing, is to convert the unit of input data (e.g., from Fahrenheit to Centigrade).

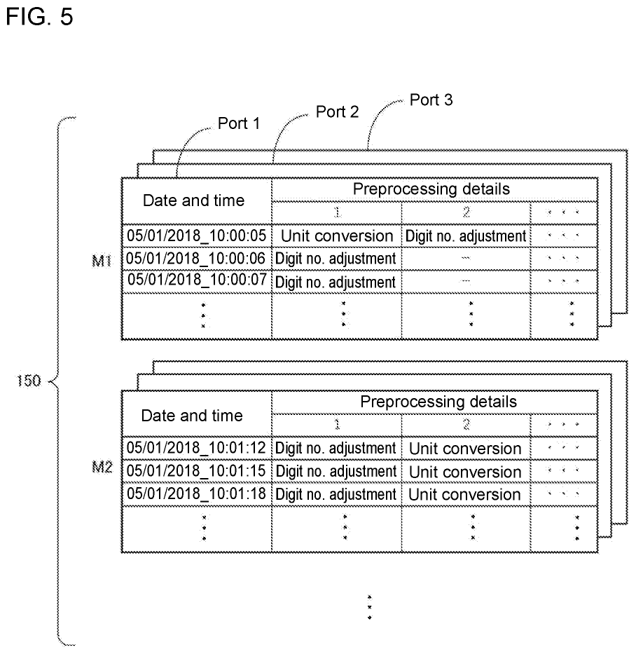

FIG. 5 is a table showing an example past determination history DB 150. The past determination history DB 150 manages the history of determination results obtained by the preprocessing determination module 110. In the example in FIG. 5, the past determination history DB 150 manages the history of determination results obtained by the preprocessing determination module 110 (FIG. 2) for each input port of the processing modules 130 (with IDs of M1, M2, . . . ). For example, the past determination history DB 150 manages the date and time and the details of preprocessing determined to be performed for each input port of the processing modules 130.

In this example, for port 1 of the processing module 130 with an ID of M1, unit conversion and digit number adjustment are determined to be performed on input data at 10:00:05 on Jan 5, 2018. The digit number adjustment is an example of preprocessing. When the number of digits of input data to be input into the processing module 130 is out of a predetermined range, the digit number adjustment is performed to adjust the number of digits of the input data to be within the predetermined range.

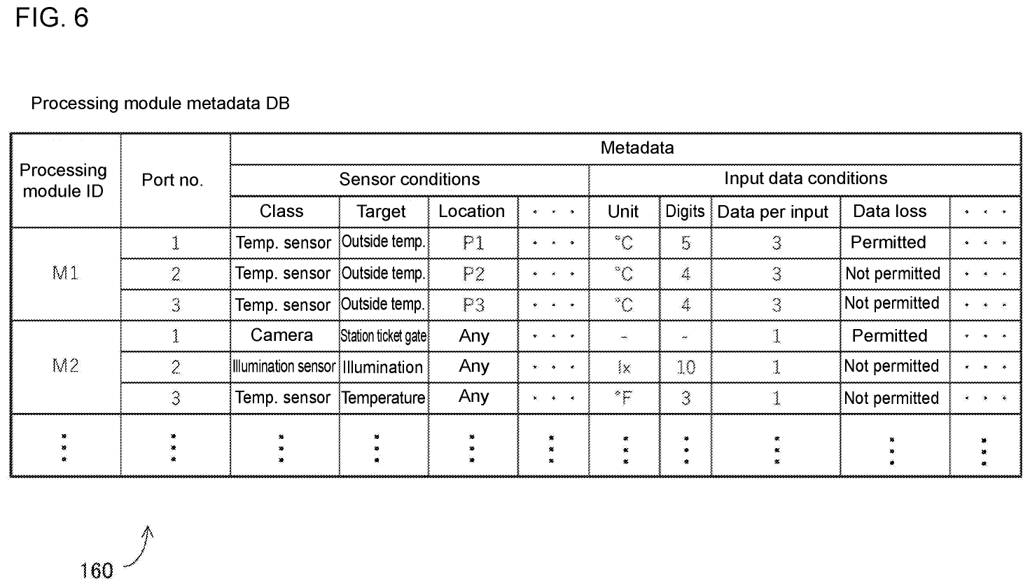

FIG. 6 is a table showing an example processing module metadata (first metadata) DB 160. The first metadata DB 160 manages the first metadata 161 (FIG. 1) indicating the conditions of input data to be input into the processing module 130. The first metadata 161 of each processing module 130 implemented by the virtual sensor management server 100 is registered in advance with the first metadata DB 160. In the example in FIG. 6, the first metadata DB 160 manages the first metadata 161 for each input port of the processing module 130.

The first metadata 161 includes, for example, sensor conditions and input data conditions. The sensor conditions are the conditions to be basically satisfied by each sensing device 12 that outputs input data (sensing data), including a class, an observation target, and an installation location.

The class refers to the type of the sensing device 12. Examples of the class include a temperature sensor, an illumination sensor, and a camera. The observation target refers to a target to be observed by the sensing device 12. Examples of the observation target include outside temperature, a station ticket gate, illumination, and temperature. The installation location refers to the location where the sensing device 12 is installed. Examples of the installation location include positions P1, P2, and P3 (P1, P2, and P3 indicate specific positions such as Kyoto Station Area).

The input data conditions relate to the attributes of input data (sensing data), including the unit, the number of digits, the number of data per input, and data loss. The unit represents, for example, the conditions regarding the unit of input data. The number of digits represents, for example, the conditions regarding the number of digits of input data. The number of data per input represents, for example, the conditions regarding the number of data used per input into an input port. The data loss represents, for example, the conditions regarding input data loss (missing).

Referring back to FIG. 3, the control program 191 is used for the virtual sensor management server 100 and is executed by the controller 180. For example, the processing modules 130, the preprocessing module 120, the preprocessing determination module 110, and the output management module 140 may be implemented by the controller 180 executing the control program 191. The control program 191 may include the preprocessing programs. When the controller 180 executes the control program 191, the control program 191 is loaded into a RAM 174. The CPU 182 in the controller 180 then interprets and executes the control program 191 loaded in the RAM 174 to control each unit.

### 2-3. Hardware Configuration of Sensing Device

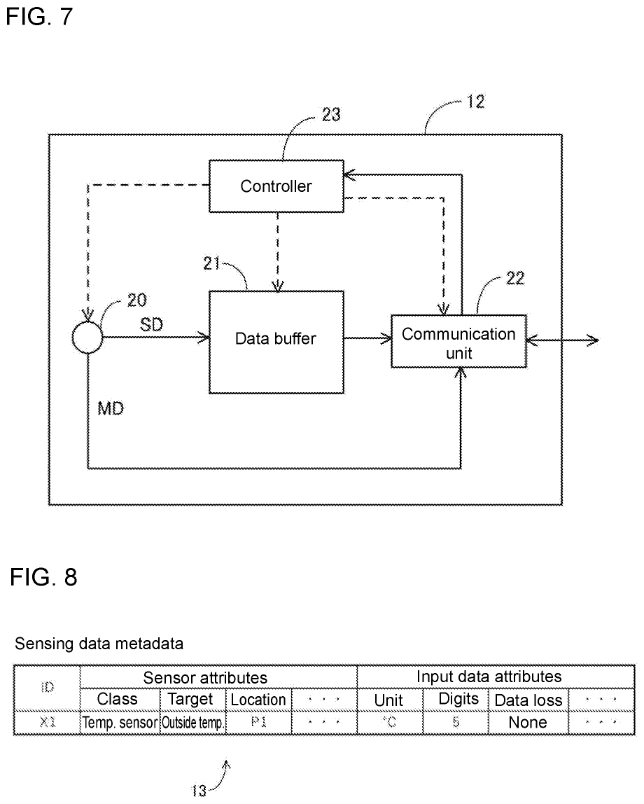

FIG. 7 is a diagram of the sensing device 12 showing its example hardware configuration. In the example in FIG. 7, the sensing device 12 includes a real sensor 20, a data buffer 21, a communication unit 22, and a controller 23.

The real sensor 20 may be an image sensor (camera), a temperature sensor, a humidity sensor, an illumination sensor, a force sensor, a sound sensor, an RFID sensor, an infrared sensor, a posture sensor, a rain sensor, a radiation sensor, or a gas sensor. The real sensor 20 may be any other sensor. The real sensor 20 outputs sensing data and the sensing data metadata (second metadata) 13 associated with the sensing data.

FIG. 8 is a table showing example sensing data metadata (second metadata) 13. In the example in FIG. 8, the second metadata 13 includes sensor attributes and input data attributes. The sensor attributes are the attributes of the sensing device 12 that outputs sensing data, including a class, an observation target, and an installation location. The input data attributes are the attributes of sensing data, including the unit, the number of digits, and data loss.

For example, the real sensor 20 checks generated sensing data and determines whether the sensing data has the unit, number of digits, and data loss to generate the second metadata 13. The same real sensor 20 may generate sensing data with varying attributes (e.g., the unit and the number of digits) due to an error caused by various factors. As described in detail later, when, for example, sensing data has the unit and the number of digits beyond a predetermined range, preprocessing is to be performed on the sensing data to convert the unit and the number of digits to be within the predetermined range.

The attributes of sensing data are affected by the attributes of the sensing device 12, and thus the attributes of input data to be input into the processing module 130 may include the sensor attributes.

Referring back to FIG. 7, the data buffer 21 temporarily stores sensing data output from the real sensor 20. The data buffer 21 is, for example, a dynamic random-access memory (DRAM) or a static random-access memory (SRAM).

The communication unit 22 communicates with external devices (e.g., the application servers 300 and the virtual sensor management server 100) external to the sensing device 12 through the Internet 15. The communication unit 22 transmits, for example, sensing data and the second metadata 13 that are output from the real sensor 20 to the virtual sensor management server 100. The communication unit 22 receives, from the virtual sensor management server 100, for example, information indicating whether sensing data is permitted to be transmitted (output) to the virtual sensor management server 100 (hereafter, output permission information). The output permission information will be described in detail later.

The controller 23 includes, for example, a CPU, a RAM, and a ROM. The controller 23 controls each unit (e.g., the real sensor 20, the data buffer 21, and the communication unit 22) in accordance with the information processing to be performed. For example, the controller 23 controls output of the sensing data temporarily stored in the data buffer 21 based on the above output permission information.

### 2-4. Software Configuration of Virtual Sensor Management Server

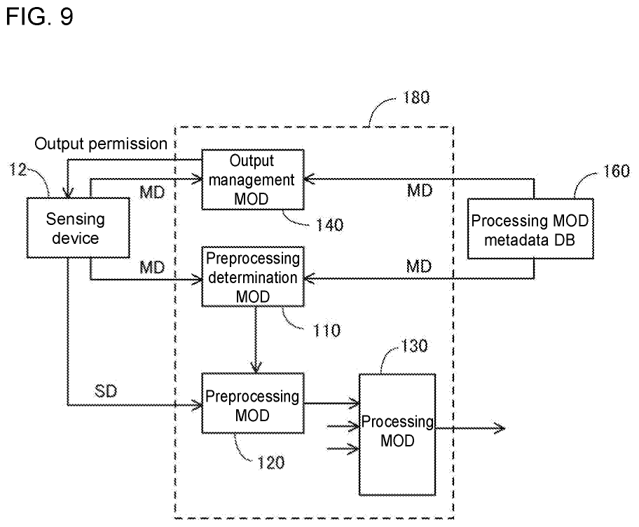

FIG. 9 is a diagram showing an example relationship between the software modules implemented by the controller 180. In the example in FIG. 9, the controller 180 implements the processing module 130, the preprocessing determination module 110, the output management module 140, and the preprocessing module 120.

The preprocessing determination module 110 performs determination for preprocessing of sensing data output from the sensing device 12 based on the first metadata 161 obtained from the first metadata DB 160 and the second metadata 13 obtained from the sensing device 12. The determination result obtained by the preprocessing determination module 110 is provided to the preprocessing module 120.

The output management module 140 determines whether the sensing device 12 is permitted to output sensing data based on the first metadata 161 and the second metadata 13. The determination result (output permission information) is transmitted to the sensing device 12.

The preprocessing module 120 preprocesses the sensing data output from the preprocessing module 120 in accordance with the determination result associated with the preprocessing and obtained from the preprocessing determination module 110. The processing module 130 receives the preprocessed sensing data. The software modules will now be described in detail one after another.

### 2-4-1. Preprocessing Determination Module

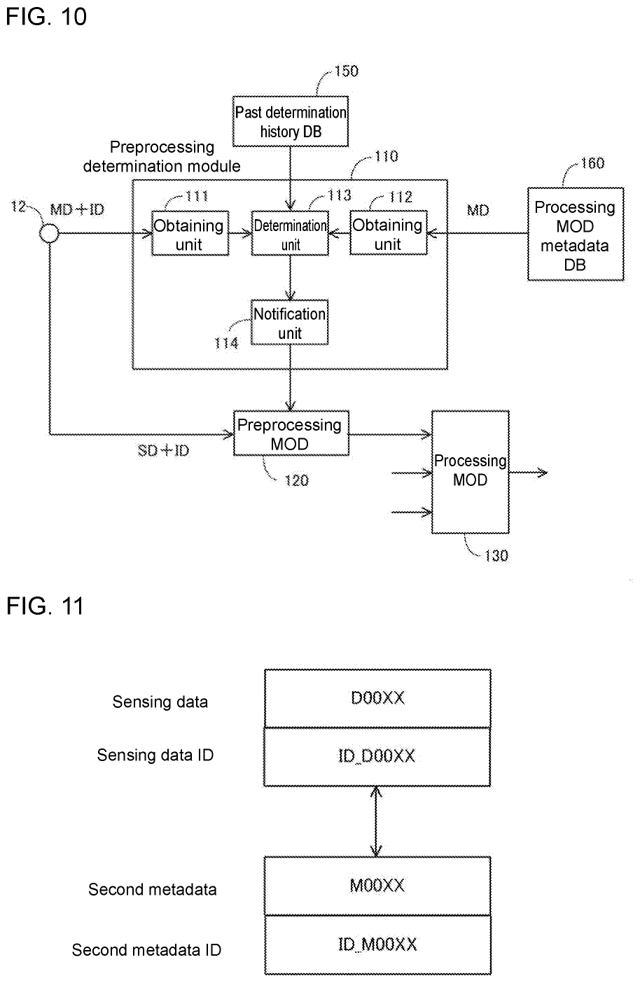

FIG. 10 is a diagram of the preprocessing determination module 110 showing its detailed example configuration. The software modules perform processing for each input port of the processing module 130. The processing for each input port may be performed in parallel or in sequence. The modules will now be described below using one input port of each processing module 130.

Referring to FIG. 10, the sensing device 12 outputs the second metadata 13 and an ID assigned to the second metadata 13 to the preprocessing determination module 110, and outputs sensing data and an ID assigned to the sensing data to the preprocessing module 120. Thus, the preprocessing determination module 110 receives no sensing data. The structure according to the present embodiment reduces the communication traffic as compared with the structure in which the preprocessing determination module 110 receives both the sensing data and the second metadata 13.

The IDs assigned to the second metadata 13 and the sensing data are associated with each other. Although the second metadata 13 and the sensing data are transmitted to different destinations, the second metadata 13 is linked with the sensing data later by referring to the IDs.

FIG. 11 is a diagram showing example IDs assigned to the data. In the example in FIG. 11, sensing data is assigned with a sensing data ID, and the second metadata 13 associated with the sensing data is assigned with a second metadata ID. In this example, the sensing data ID and the second metadata ID have the same last four digits (00XX). In this example, the second metadata 13 can be linked with the sensing data later by referring to the last four digits of the IDs.

Referring back to FIG. 10, the preprocessing determination module 110 includes obtaining units 111 and 112, a determination unit 113, and a notification unit 114. The obtaining unit 111 obtains the second metadata 13 and the ID assigned to the second metadata 13. The obtaining unit 112 obtains the first metadata 161 (FIG. 1) associated with the input port from the first metadata DB 160.

The determination unit 113 determines whether preprocessing is to be performed on sensing data based on the second metadata 13 obtained by the obtaining unit 111 and the first metadata 161 obtained by the obtaining unit 112, and determines the details of the preprocessing when the preprocessing is to be performed.

For example, the determination unit 113 determines that preprocessing is not to be performed when the input data attributes indicated by the second metadata 13 satisfy the input data conditions indicated by the first metadata 161, and determines that preprocessing is to be performed when the input data attributes indicated by the second metadata 13 fail to satisfy the input data conditions indicated by the first metadata 161. Further, when the preprocessing is to be performed, the determination unit 113 determines the details of the preprocessing to be performed in accordance with, for example, the details of the input conditions that the input data attributes fail to satisfy. When, for example, the number of digits as the input data condition is three and the number of digit as the input data attribute is five, the determination unit 113 determines that preprocessing is to be performed to reduce two digits.

Further, the determination unit 113 refers to the past determination history DBs 150 to determine whether the preprocessing determined to be performed is the same as the immediately preceding preprocessing. When the two sets of preprocessing are the same, the preprocessing program to be performed has already been read, thus eliminating searching of the preprocessing program DB 170 (FIG. 4) again. This enables more appropriate determination for preprocessing by referring to the past determination history.

The notification unit 114 notifies the preprocessing module 120 of the determination result obtained by the determination unit 113. For example, the notification unit 114 notifies whether preprocessing is to be performed, the details of the preprocessing to be performed, and whether the same preprocessing immediately precedes, together with the ID assigned to the second metadata 13 to the preprocessing module 120.

### 2-4-2. Output Management Module

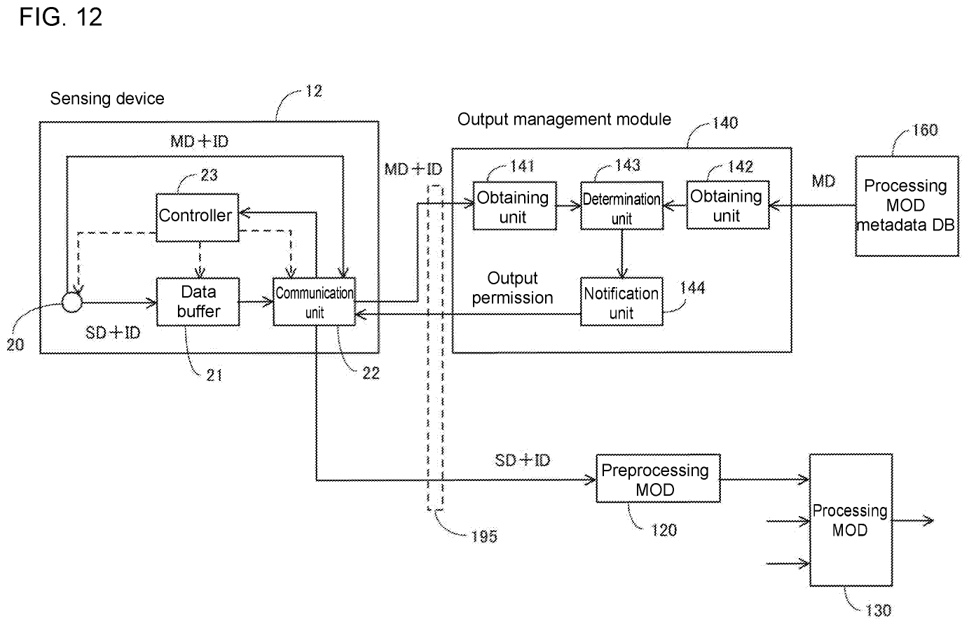

FIG. 12 is a diagram of the output management module 140 showing its detailed example configuration. In the example in FIG. 12, the output management module 140 includes obtaining units 141 and 142, a determination unit 143, and a notification unit 144. The obtaining unit 141 obtains (receives) the second metadata 13 and the ID assigned to the second metadata 13 from the sensing device 12 through the communication I/F 195. The obtaining unit 142 obtains the first metadata 161 associated with the input port from the first metadata DB 160.

The determination unit 143 determines whether the sensing device 12 is permitted to output sensing data based on the second metadata 13 obtained by the obtaining unit 111 and the first metadata 161 obtained by the obtaining unit 112. For example, the determination unit 143 determines that the sensing data is permitted to be output when the sensor attributes indicated by the second metadata 13 satisfy the sensor conditions indicated by the first metadata 161, and determines that the sensing data is not permitted to be output when the sensor attributes indicated by the second metadata 13 fail to satisfy the sensor conditions indicated by the first metadata 161. Thus, the determination unit 143 determines that the sensing device 12 is not permitted to output sensing data when the sensing data is preprocessed but fails to satisfy the conditions of input data to be input into the processing module 130.

The notification unit 144 transmits the output permission information indicating the determination result obtained by the determination unit 143 together with the ID assigned to the second metadata 13 to the sensing device 12 through the communication I/F 195.

When the sensing device 12 receives the output permission information through the communication unit 22, the controller 23 controls output of the sensing data stored in the data buffer 21 in accordance with the received output permission information. When, for example, the received output permission information indicates that the output is permitted, the controller 23 controls the data buffer 21 and the communication unit 22 to transmit the sensing data assigned with the ID corresponding to the ID received together with the output permission information to the preprocessing module 120. When, for example, the received output permission information indicates that the output is not permitted, the controller 23 deletes the sensing data assigned with the ID corresponding to the ID received together with the output permission information from the data buffer 21.

### 2-4-3. Preprocessing Module

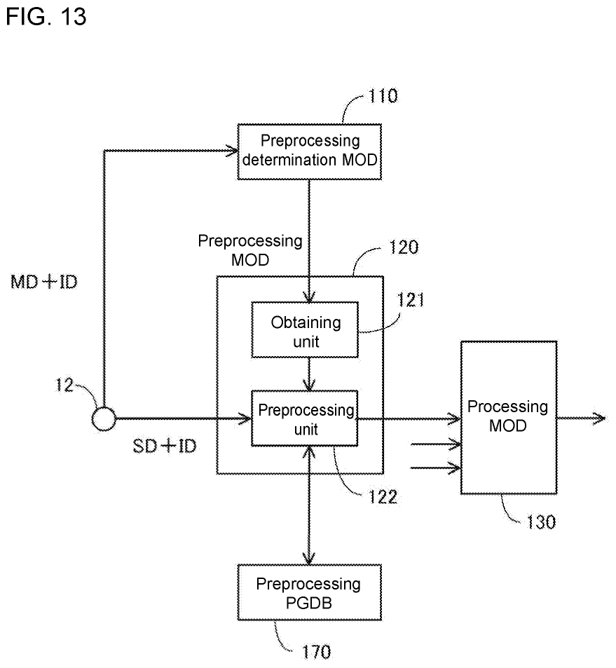

FIG. 13 is a diagram of the preprocessing module 120 showing its detailed example configuration. In the example in FIG. 13, the preprocessing module 120 includes an obtaining unit 121 and a preprocessing unit 122. The obtaining unit 121 obtains the determination result obtained by the preprocessing determination module 110 and the ID assigned to the second metadata 13.

The determination result obtained by the obtaining unit 121 may indicate that preprocessing is to be performed and is different from the immediately preceding preprocessing. In this case, the preprocessing unit 122 searches, for example, the preprocessing program DB 170 for a preprocessing program corresponding to the preprocessing indicated by the determination result, and reads the preprocessing program. The preprocessing unit 122 preprocesses the sensing data assigned with the ID corresponding to the ID obtained by the obtaining unit 121. The preprocessing unit 122 subjects the sensing data to preprocessing performed by executing the read preprocessing program. The processing module 130 receives the sensing data preprocessed by the preprocessing module 120.

The determination result obtained by the obtaining unit 121 may indicate that preprocessing is to be performed and is the same as the immediately preceding preprocessing. In this case, for example, the preprocessing unit 122 does not search the preprocessing program DB 170. The preprocessing unit 122 subjects the sensing data to preprocessing performed by executing the preprocessing program that has already been read. The processing module 130 receives the sensing data preprocessed by the preprocessing module 120.

### 3. Operations

### 3-1. Preprocessing Determination Operation

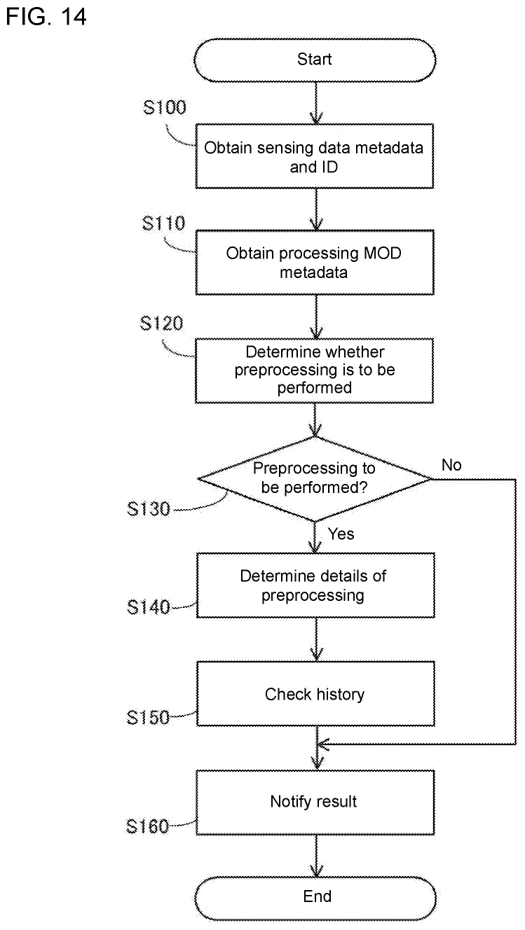

FIG. 14 is a flowchart showing an example of a preprocessing determination operation. The processing in this flowchart is performed when the controller 180 operates as the preprocessing determination module 110 in response to, for example, the second metadata 13 received from the sensing device 12. As described above, preprocessing is determined for each input port of the processing module 130. The procedure will be described using one input port of one processing module 130.

Referring to FIG. 14, the controller 180 obtains the second metadata 13 and the ID assigned to the second metadata from the sensing device 12 (step S100). The controller 180 obtains the first metadata 161 corresponding to the input port from the first metadata DB 160 (step S110). The controller 180 determines whether preprocessing is to be performed on the sensing data assigned with the ID corresponding to the ID assigned to the second metadata based on the first metadata 161 and the second metadata 13 (step S120). The controller 180 determines whether the preprocessing is determined to be performed (step S130).

When the preprocessing is determined not to be performed (No in step S130), the preprocessing determination module 110 (controller 180) notifies the preprocessing module 120 that the preprocessing is not to be performed and of the ID assigned to the second metadata 13 (step S160).

When the preprocessing is determined to be performed (Yes in step S130), the controller 180 determines the details of the preprocessing to be performed (step S140). The controller 180 refers to the past determination history DBs 150 to determine whether the preprocessing determined to be performed is the same as the immediately preceding preprocessing (step S150). Then, the preprocessing determination module 110 (controller 180) notifies the preprocessing module 120 of the determination result together with the ID assigned to the second metadata 13 (step S160).

In this manner, the preprocessing determination module 110 performs determination for preprocessing of input data to be input into the processing module 130 based on the first metadata 161 and the second metadata 13. The preprocessing determination module 110 thus performs determination for preprocessing using the conditions and the attributes of input data to be input into the processing module 130. The preprocessing determination module 110 uses relevant information about preprocessing and can thus perform appropriate determination for the preprocessing.

### 3-2. Output Management Operation

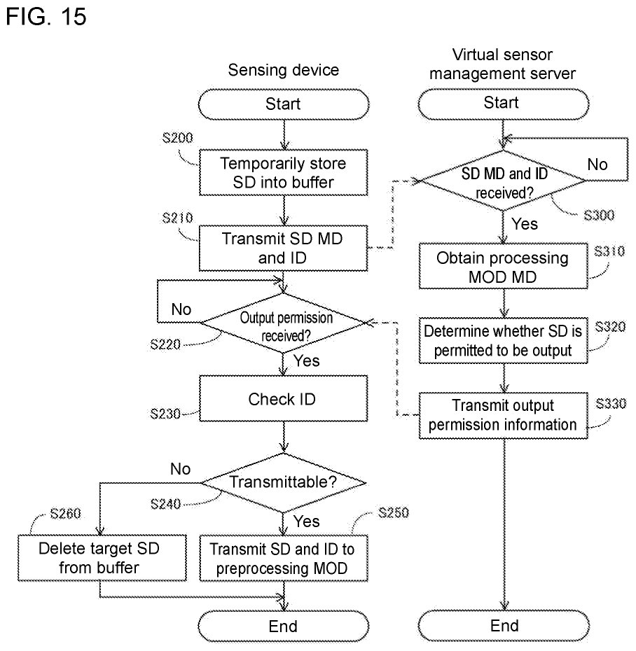

FIG. 15 is a flowchart showing an example operation for managing output of sensing data from the sensing device 12 to the processing module 130. The processing in this flowchart is performed in response to, for example, sensing data generated by the sensing device 12. As described above, the output of sensing data is managed for each input port of the processing module 130. The procedure will be described using one input port of one processing module 130.

Referring to FIG. 15, the left part of the flowchart is performed by the controller 23 (sensing device 12). The right part of the flowchart is performed when the controller 180 (virtual sensor management server 100) operates as the output management module 140.

Referring to the left part of FIG. 15, the controller 23 controls the data buffer 21 to temporarily store the sensing data output from the real sensor 20 (FIG. 7) (step S200). The controller 23 controls the communication unit 22 to transmit, to the virtual sensor management server 100, the second metadata 13 associated with the sensing data temporarily stored in the data buffer 21 and the ID assigned to the second metadata 13 (step S210).

The controller 23 then determines whether the output permission information or other information associated with the sensing data is received from the virtual sensor management server 100 (step S220). When determining that the output permission information or other information is not received (No in step S220), the controller 23 waits until such information is received.

Referring to the right part of FIG. 15, the controller 180 determines whether the second metadata 13 and the ID assigned to the second metadata 13 are received (step S300). When determining that the sets of data are not received (No in step S300), the controller 180 waits until the sets of data are received.

When determining that the sets of data are received (Yes in step S300), the controller 180 obtains the first metadata 161 associated with the input port of the processing module 130 from the first metadata DB 160 (step S310). The controller 180 determines whether the sensing device 12 outputs the sensing data associated with the second metadata 13 to the processing module 130 based on the first metadata 161 and the second metadata 13 (step S320). The controller 180 controls the communication I/F 195 to transmit the output permission information indicating the determination result obtained in step S320 together with the ID assigned to the second metadata 13 to the sensing device 12 (step S330).

Referring back to the left part of FIG. 15, when determining that the output permission information and the ID are received in step S220 (Yes in step S220), the controller 23 checks the ID to identify the target sensing data from sensing data temporarily stored in the data buffer 21 (step S230).

The controller 23 refers to the output permission information to determine whether the identified sensing data is permitted to be output (transmitted) (step S240). When determining that the target sensing data is transmittable (Yes in step S240), the controller 23 controls the communication unit 22 to transmit the target sensing data and the ID assigned to the sensing data to the preprocessing module 120 (virtual sensor management server 100) (step S250). When determining that the target sensing data is not transmittable (No in step S240), the controller 23 deletes the target sensing data from the data buffer 21 (step S260).

In this manner, the output management module 140 notifies the sensing device 12 whether sensing data is permitted to be output to the processing module 130 based on the first metadata 161 and the second metadata 13. More specifically, the output management module 140 notifies the sensing device 12 whether the sensing data is permitted to be output using the conditions of input data to be input into the processing module 130 and the attributes of the sensing data temporarily stored in the data buffer 21. The output management module 140 thus notifies the sensing device 12 of the output permission information using relevant information. This reduces the likelihood that the processing module 130 receives sensing data failing to satisfy predetermined conditions and performs inappropriate processing.

The output management module 140 notifies the sensing device 12 of the output permission information together with the ID assigned to the second metadata 13. The output management module 140 causes the sensing device 12 to refer to the ID and determine whether each piece of sensing data is permitted to be output.

### 3-3. Preprocessing

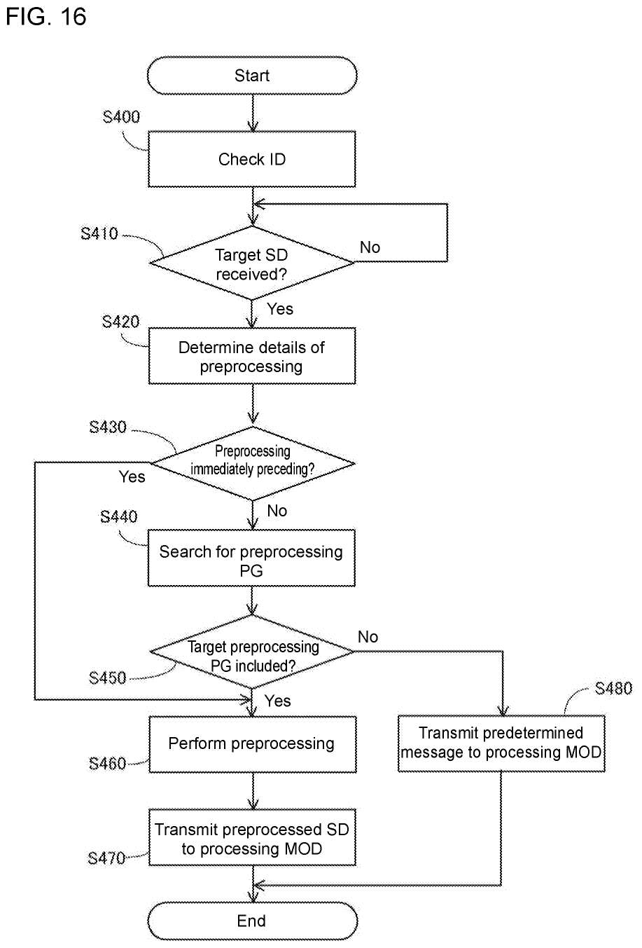

FIG. 16 is a flowchart showing an example of preprocessing. The processing in this flowchart is performed when the controller 180 operates as the preprocessing module 120 in response to the determination result and the ID (assigned to the second metadata 13) notified from the preprocessing determination module 110. As described above, the preprocessing of sensing data is performed for each input port of the processing module 130. The procedure will be described using one input port of one processing module 130.

Referring to FIG. 16, the controller 180 checks the ID assigned to the sensing data received from the sensing device 12 with the ID notified from the preprocessing determination module 110 (step S400). The controller 180 determines whether the sensing data assigned with the ID corresponding to the ID notified from the preprocessing determination module 110 is received (step S410).

When determining that the sensing data assigned with the ID corresponding to the ID notified from the preprocessing determination module 110 is not received (No in step S410), the controller 180 waits until the sensing data is received. When determining that the sensing data assigned with the ID corresponding to the ID notified from the preprocessing determination module 110 is received (Yes in step S410), the controller 180 refers to the determination result obtained from the preprocessing determination module 110 and determines preprocessing to be performed on the target sensing data (step S420).

Additionally, the controller 180 refers to the determination result obtained from the preprocessing determination module 110 to determine whether the preprocessing to be performed is the same as the immediately preceding preprocessing performed on sensing data (step S430).

When determining that the preprocessing to be performed is different from the immediately preceding preprocessing performed on sensing data (No in step S430), the controller 180 searches the preprocessing program DB 170 for a preprocessing program to be performed (step S440). The controller 180 determines whether the preprocessing program DB 170 includes the preprocessing program to be performed (step S450). When determining that the preprocessing program DB 170 includes the preprocessing program to be performed (Yes in step S450), the controller 180 reads and executes the preprocessing program to preprocess the target sensing data (step S460). Then, the preprocessing module 120 (controller 180) transmits the preprocessed sensing data to the processing module 130 (step S470).

When determining that the preprocessing to be performed is the same as the immediately preceding preprocessing performed on sensing data in step S430 (Yes in step S430), the controller 180 executes the preprocessing program that has already been read to preprocess the target sensing data (step S460).

When determining that the preprocessing program DB 170 does not include the preprocessing program to be performed in step S450 (No in step S450), the preprocessing module 120 (controller 180) transmits a predetermined message to the processing module 130 together with the sensing data yet to be preprocessed (step S480). The predetermined message indicates that, for example, the preprocessing program to be performed is unavailable.

In this manner, the preprocessing module 120 preprocesses sensing data in accordance with the determination result obtained by the preprocessing determination module 110. The preprocessing module 120 thus uses the conditions and the attributes of input data (sensing data) to be input into the processing module 130 to preprocess the input data. The preprocessing module 120 appropriately preprocesses input data to be input into the processing module 130, thus reducing the likelihood that inappropriate data is input into the processing module 130.

The sensing data is associated with the second metadata 13 using IDs. The determination for preprocessing is performed for each piece of input data using the IDs. Thus, the preprocessing module 120 appropriately preprocesses each piece of input data based on the determination result.

### 4. Features

As described above, the preprocessing determination apparatus (module) 110 according to the present embodiment performs determination for preprocessing of input data to be input into the processing module 130 based on the first metadata 161 and the second metadata 13. The preprocessing determination apparatus (module) 110 thus performs determination for preprocessing using the conditions and the attributes of input data to be input into the processing module 130. The preprocessing determination apparatus (module) 110 uses relevant information about preprocessing and can thus perform appropriate determination for the preprocessing.

The processing module 130 is an example of a processing module in an aspect of the present invention, and the preprocessing determination module 110 is an example of a preprocessing determination apparatus in an aspect of the present invention. The first metadata 161 is an example of first metadata in an aspect of the present invention, and the second metadata 13 is an example of second metadata in an aspect of the present invention. The obtaining unit 112 is an example of a first obtaining unit in an aspect of the present invention, the obtaining unit 111 is an example of a second obtaining unit in an aspect of the present invention, and the determination unit 113 is an example of a determination unit in an aspect of the present invention. The sensing device 12 is an example of a device in an aspect of the present invention, and the storage 190 is an example of a storage in an aspect of the present invention.

### 5. Modifications

Although the embodiments have been described above, the present invention is not limited to these embodiments and can be modified in various manners without departing from the sprit and scope of the invention. Modifications will be described below. The modifications described below may be combined as appropriate.

5-1

In the above embodiment, each input port of the processing module 130 receives sensing data input from any sensing device 12. However, a unit other than the sensing device 12 may output data to each input port. For example, a storage storing a data set or a virtual sensor may output data to each input port. The data set includes multiple pieces of data generated in advance. An example of a data set is a set of sensing data obtained in advance by observing an object for a predetermined period. A unit other than the sensing device 12 may output data to each input port. Thus, input data input into the processing module 130 may be other than sensing data. Examples of the input data include shopping history data of each user at a shopping site and score data of each user at a game site.

5-2

The processing performed by the virtual sensor management server 100 in the above embodiment may be implemented by, for example, multiple servers.

5-3

Each piece of sensing data may not be associated with the second metadata 13. For example, multiple pieces of sensing data may be associated with a single piece of second metadata 13. In this case, the same preprocessing is performed on the multiple pieces of sensing data associated with the same second metadata 13.

1. A preprocessing determination apparatus for performing determination for preprocessing of input data to be input into a processing module,
processing module being configured to generate, based on at least one piece of the input data, output data different from the at least one piece of input data,
the processing module being associated with first metadata indicating a condition of the input data,
the input data being associated with second metadata indicating an attribute of the input data,
the preprocessing determination apparatus, comprising:
a first obtaining unit configured to obtain the first metadata;
a second obtaining unit configured to obtain the second metadata; and
a determination unit configured to perform the determination for the preprocessing of the input data based on the first metadata and the second metadata.

2. The preprocessing determination apparatus according to claim 1, wherein
the input data is output to the processing module by a device,
the device outputs the input data and the second metadata separately, and
the second metadata is output to the preprocessing determination apparatus by the device.

3. The preprocessing determination apparatus according to claim 2, wherein the input data is associated with the second metadata using an identification.

4. The preprocessing determination apparatus according to claim 1, further comprising:
a storage configured to store a past determination result obtained by the determination unit,
wherein the determination unit performs the determination for the preprocessing based on the first metadata, the second metadata, and the past determination result.

5. The preprocessing determination apparatus according to claim 1, wherein
the preprocessing is performed on the input data to cause the input data to satisfy the condition of the input data.

6. The preprocessing determination apparatus according to claim 1, wherein
the input data is output to the processing module by a device,
the device comprises a sensor, and
the input data comprises sensing data generated by the sensor.

7. The preprocessing determination apparatus according to claim 1, wherein
the processing module generates the output data based on a plurality of pieces of the input data.

8. The preprocessing determination apparatus according to claim 1, wherein
the input data is output to the processing module by a device, and
the processing module switches the device that outputs the input data to the processing module.

9. The preprocessing determination apparatus according to claim 1, wherein
the input data is output to the processing module by a device, and
the processing module and the device that outputs the input data to the processing module form a virtual sensor.

10. A preprocessing determination method for performing determination for preprocessing of input data to be input into a processing module,
the processing module being configured to generate, based on at least one piece of the input data, output data different from the at least one piece of input data,
the processing module being associated with first metadata indicating a condition of the input data,
the input data being associated with second metadata indicating an attribute of the input data,
the preprocessing determination method, comprising:
obtaining the first metadata;
obtaining the second metadata; and
performing the determination for the preprocessing of the input data based on the first metadata and the second metadata.

11. A non-transitory computer-readable storage medium storing a program for causing a computer to perform determination for preprocessing of input data to be input into a processing module,
the processing module being configured to generate, based on at least one piece of the input data, output data different from the at least one piece of input data,
the processing module being associated with first metadata indicating a condition of the input data,
the input data being associated with second metadata indicating an attribute of the input data,
the program, which when read and executed, causes for the computer to perform operations comprising:
obtaining the first metadata;
obtaining the second metadata; and
performing the determination for the preprocessing of the input data based on the first metadata and the second metadata.

12. The preprocessing determination apparatus according to claim 2, further comprising:
a storage configured to store a past determination result obtained by the determination unit,
wherein the determination unit performs the determination for the preprocessing based on the first metadata, the second metadata, and the past determination result.

13. The preprocessing determination apparatus according to claim 2, wherein
the preprocessing is performed on the input data to cause the input data to satisfy the condition of the input data.

14. The preprocessing determination apparatus according to claim 2, wherein
the input data is output to the processing module by a device,
the device comprises a sensor, and
the input data comprises sensing data generated by the sensor.

15. The preprocessing determination apparatus according to claim 2, wherein
the processing module generates the output data based on a plurality of pieces of the input data.

16. The preprocessing determination apparatus according to claim 2, wherein
the input data is output to the processing module by a device, and
the processing module switches the device that outputs the input data to the processing module.

17. The preprocessing determination apparatus according to claim 2, wherein
the input data is output to the processing module by a device, and
the processing module and the device that outputs the input data to the processing module form a virtual sensor.

18. The preprocessing determination apparatus according to claim 3, further comprising:
a storage configured to store a past determination result obtained by the determination unit,
wherein the determination unit performs the determination for the preprocessing based on the first metadata, the second metadata, and the past determination result.

19. The preprocessing determination apparatus according to claim 3, wherein
the preprocessing is performed on the input data to cause the input data to satisfy the condition of the input data.

20. The preprocessing determination apparatus according to claim 3, wherein
the input data is output to the processing module by a device,
the device comprises a sensor, and
the input data comprises sensing data generated by the sensor.
